(19) United States
(12) Patent Application Publication
(10) Pub. No.: US 2005/0053445 A1
(43) Pub. Date: Mar. 10, 2005

(54) Self-securing fastener

(75) Inventor: Stephen G. Miller, Allentown, PA (US)

Correspondence Address: ROTHWELL ,FIGG, ERNEST & MANBECK, 1425 K STREET N.W., SUITE 800, WASHINGTON, DC, 20005, US

(73) Assignee: Mack Trucks, Inc., Allentown, PA (US)

(21) Appl. No.: 10/929,430

(22) Filed: Aug. 31, 2004

Related U.S. Application Data
(60) Provisional application No. 60/499,724, filed on Sep. 4, 2003.

(51) Int. Cl. F16B 21/00

(52) U.S. Cl. 411/344

(57) ABSTRACT

A self-securing fastener may include a shaft, a shank may be disposed at a head end of the shaft may have a primary side substantially parallel to an axis of rotation of the shaft and a plurality of secondary sides arranged about the axis of rotation, the primary side and the secondary sides may describe a pattern when viewed from a direction substantially normal to the axis of rotation, an external thread may be disposed substantially helically at a tail end of the shaft distal from the head end, and an appendage may be disposed fixedly to the primary side and extending substantially radially to the axis of rotation, the appendage may have a thrust face substantially normal to the axis of rotation, wherein the shank is prevented substantially from turning when the appendage is inserted in an aperture may have a shape substantially similar to the pattern, the thrust face abuts substantially an edge of the aperture, and a nut may have an internal thread substantially complementary to the external thread is rotated along the shaft.

### CROSS-REFERENCE TO RELATED APPLICATIONS

This application claims priority to Provisional Application Ser. No. 60/499,724, filed Sep. 4, 2003, the disclosure of which is incorporated by reference.

### BACKGROUND OF THE INVENTION

### FIELD OF THE INVENTION

The invention relates to the field of fasteners, and more particularly to fasteners of the self-securing variety.

### DESCRIPTION OF THE RELATED ART

A head of a fastener, such as a bolt, may be square or hexagonal in shape to fit a wrench or spanner. The wrench may be used either to turn the head while the nut is held stationary, or else to hold the head stationary while the nut is turned, in order to tighten the fastener. A problem arises when tightening fasteners in confined spaces due to the fact that the head of, e.g. a bolt may be inaccessible to a wrench. If the head is inaccessible or difficult to reach, it may be difficult or impossible to apply a wrench to the head to prevent the head, and hence the bolt itself, from turning while the nut is being tightened.

If the head is free to turn while the nut is being tightened it may be impossible to tighten the nut completely, or even tighten it at all. Even if the head, and consequently the fastener, can be immobilized from the thread end, it may still be inconvenient to tighten the fastener efficiently. Finally, if the head turns while the nut is being tightened the torque placed on the fastener may deviate significantly from the optimum value, leading to excessive bolt stresses and possibly premature failure of the fastener.

### SUMMARY OF THE INVENTION

A primary object of the invention is to overcome the deficiencies of the related art described above by providing a self-securing fastener. The present invention achieves these objects and others by providing a self-securing fastener.

In several aspects, the invention may provide a self-securing fastener. In particular, in a first aspect, a self-securing fastener includes a shaft, a shank may be disposed at a head end of the shaft having a primary side substantially parallel to an axis of rotation of the shaft and a plurality of secondary sides arranged about the axis of rotation, the primary side and the secondary sides may describe a pattern when viewed from a direction substantially normal to the axis of rotation, an external thread may be disposed substantially helically at a tail end of the shaft distal from the head end, and an appendage may be disposed fixedly to the primary side and extending substantially radially to the axis of rotation, the appendage having a thrust face substantially normal to the axis of rotation, wherein the shank may be prevented substantially from turning when the appendage is inserted in an aperture having a shape substantially similar to the pattern, the thrust face abuts substantially an edge of the aperture, and a nut may have an internal thread substantially complementary to the external thread may be rotated along the shaft.

In a second aspect, a method of self-securing a fastener includes passing an appendage through an aperture having a shape, fitting a shank attached to the appendage into the aperture, the shank having a pattern substantially similar to the shape, rotating a shaft attached to the shank from an oblique position substantially oblique to the aperture to a normal position substantially normal to the aperture, abutting a thrust face of the appendage against an edge of the aperture, and rotating a nut having an internal thread substantially helically about the shaft toward the shank, and preventing the shank from turning substantially in the aperture while the nut is rotated helically about the shaft.

In a third aspect, a system for self-securing a fastener includes means for passing an appendage through an aperture having a shape, means for fitting a shank attached to the appendage into the aperture, the shank having a pattern substantially similar to the shape, means for rotating a shaft attached to the shank from an oblique position substantially oblique to the aperture to a normal position substantially normal to the aperture, means for abutting a thrust face of the appendage against an edge of the aperture, and means for rotating a nut having an internal thread substantially helically about the shaft toward the shank, and means for preventing the shank from turning substantially in the aperture while the nut is rotated helically about the shaft.

The above and other features and advantages of the present invention, as well as the structure and operation of various embodiments of the present invention, are described in detail below with reference to the accompanying drawings.

### BRIEF DESCRIPTION OF THE SEVERAL VIEWS OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIG. 1 is a three-quarter view of a self-securing fastener according to a first embodiment of the invention;

FIG. 2A is a side view of a self-securing fastener according to the embodiment shown in FIG. 1;

FIG. 2B is a nut for use with a self-securing fastener according to the embodiment shown in FIG. 1;

FIG. 2C is a section cut through the nut shown in FIG. 2B;

FIG. 3 is an exploded view of a battery carrier for use with a self-securing fastener according to the embodiment shown in FIG. 1;

FIG. 4A is a side view of a self-securing fastener according to the embodiment shown in FIG. 1;

FIG. 4B is a side view of a self-securing fastener according to the embodiment shown in FIG. 1;

FIG. 5 is an exploded view of a battery carrier for use with a self-securing fastener according to the embodiment shown in FIG. 1;

FIG. 6 is a three-quarter detail view of a head of a self-securing fastener according to the embodiment shown in FIG. 1; and

FIGS. 7A-7G are shapes of a shank for use with a self-securing fastener according to the embodiment shown in FIG. 1.

### DETAILED DESCRIPTION OF THE PREFERRED EMBODIMENTS

It would be desirable for a fastener to be tightened easily in, e.g. confined spaces, even if the head is inaccessible. It would further be desirable for the head to be held stationary while the nut is turned, without applying a wrench to the head, in order to tighten the fastener. It would further be desirable for the head to be held stationary while the nut is turned, even if the head is accessible, to dispense with the time required to fit the wrench to the head. Finally, it would be desirable for the head to be held stationary while the nut is turned, even if the head is inaccessible, to apply the proper torque to the fastener to prevent excessive bolt stresses and premature failure of the fastener.

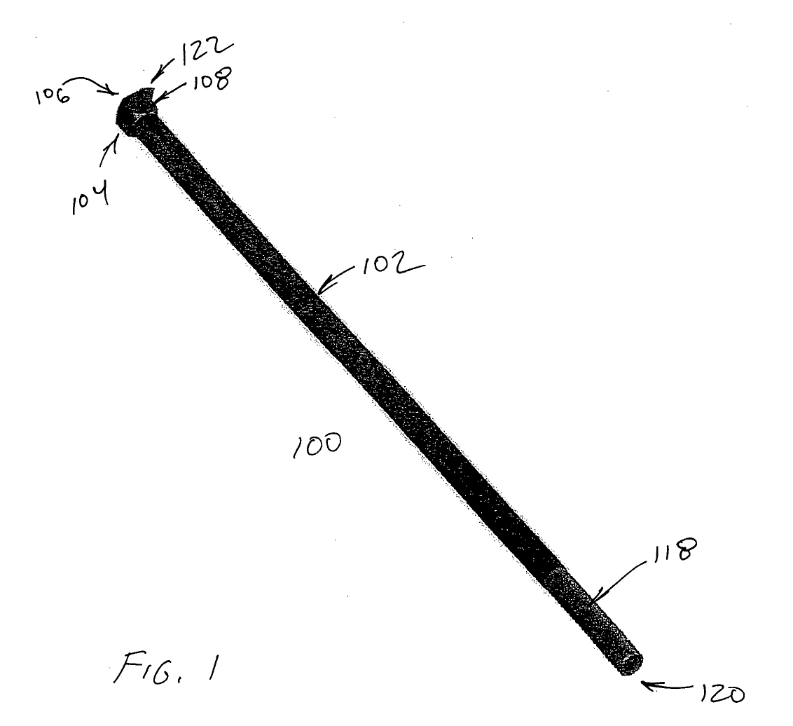

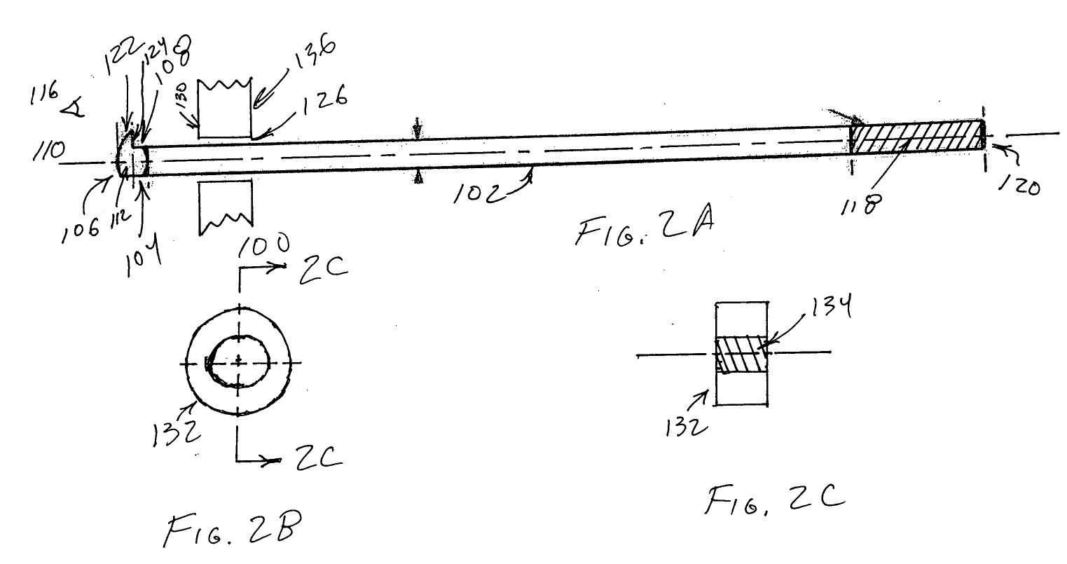

In FIGS. 1 and 2A is shown a self-securing fastener 100 according to a first embodiment of the invention. Self-securing fastener 100 may include a shaft 102 having a head end 106 and a tail end 120 distal from head end 106. In one embodiment, an external thread 118 may be disposed substantially helically at tail end 120 of shaft 102. In several embodiments, thread 118 could be a single, double, or triple lead thread. In one embodiment, shown in FIGS. 2B and 2C, a nut 132 may be rotated substantially helically along shaft 102 to clamp a member 136. In this embodiment, nut 132 may have an internal thread 134 substantially complementary to external thread 118.

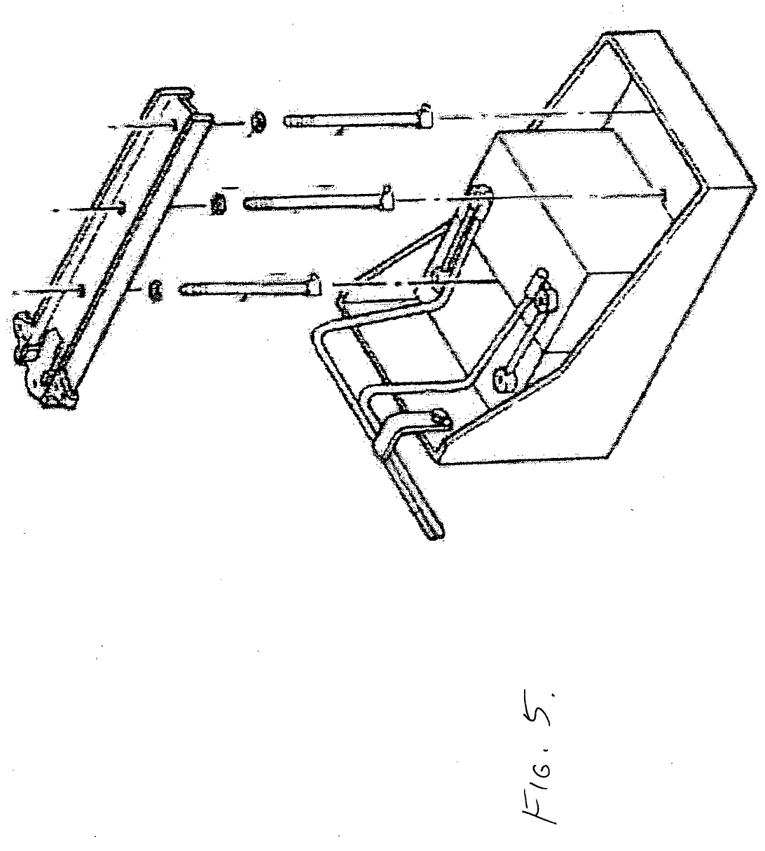

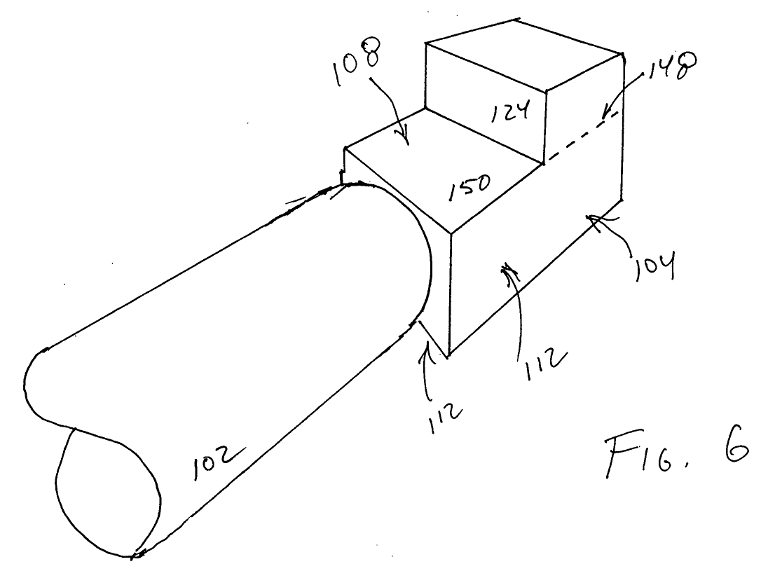

In one embodiment, a shank 104 may be disposed at head end 106 of shaft 102, as shown in FIG. 6. Shank 104 may have a primary side 108 substantially parallel to an axis of rotation 110 of shaft 102 and a plurality of secondary sides 112 arranged about axis of rotation 110. In one embodiment, primary side 108 and secondary sides 112 may substantially parallel to axis of rotation 110. In another embodiment, primary side 108 and secondary sides 112 may be skewed substantially to axis of rotation 110. In this embodiment, a member 136 clamped by self-securing fastener 100 may be wedge-shaped.

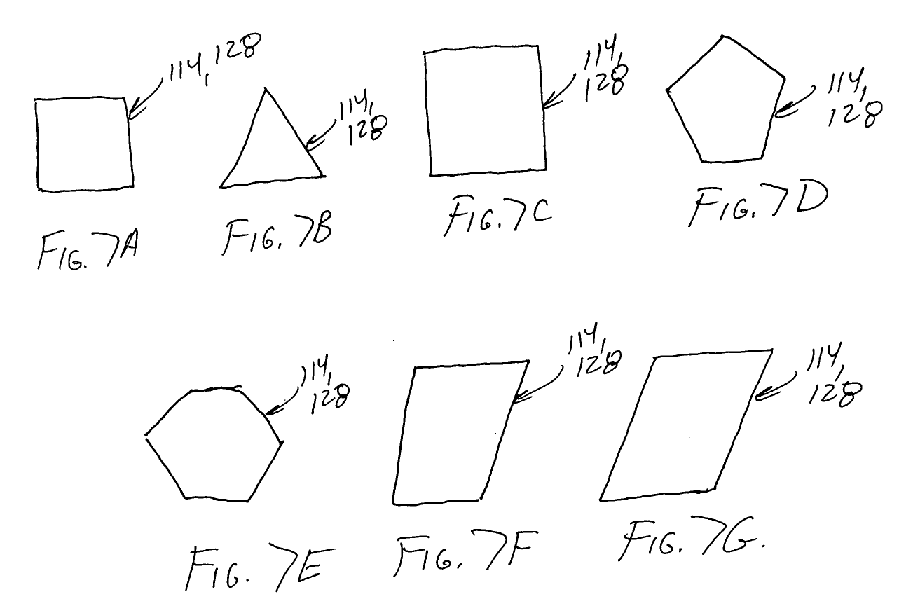

In one embodiment, primary side 108 and secondary sides 112 may describe a pattern 114 when viewed from a direction 116 substantially normal to axis of rotation 110. In several embodiments, pattern 114 may be a square, a triangle, a quadrilateral, a pentagon, a hexagon, a rhombus, or a trapezoid, as shown in FIGS. 7A-7G.

In one embodiment, shank 104 may be inserted in an aperture 126 in member 136 having a shape 128 substantially similar to pattern 114. In this embodiment, only shank 104 is inserted in an aperture 126. In this embodiment, neither tail end 102 nor shaft 102 will also be inserted or passed through aperture 126 after shank 104 has been inserted in aperture 126. Thus aperture 126 can be a ‘blind’ or inaccessible hole, since neither tail end 102 nor shaft 102 has to be inserted or passed through aperture 126 as well.

Since aperture 126 has a shape 128 substantially similar to pattern 114, however, shank 102 may be aligned with aperture 126 in order to fit inside it. In this embodiment, shank 104 may be prevented substantially from turning in an aperture 126 by the similarity between shape 128 and pattern 114. In several embodiments, a fit between shank 104 and aperture 126 may be a slip fit, or an interference fit.

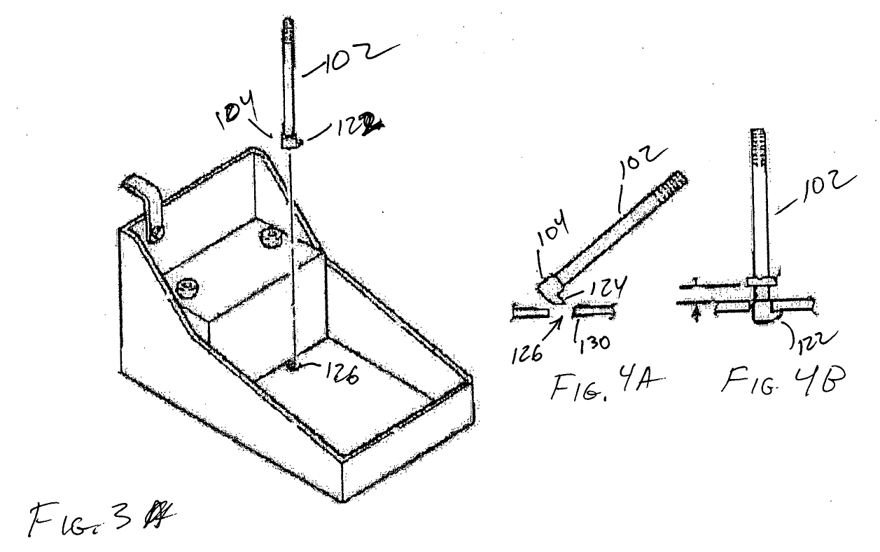

In one embodiment, an appendage 122 may be disposed fixedly to primary side 108 and extend substantially radially to axis of rotation 110. In this embodiment, appendage 122 may extend from an upper portion 148 of primary side 108, leaving a lower portion 150 of primary side 108 to form one side of pattern 114. In several embodiments, appendage 122 may be a hook, a claw, or a crow's foot. In one embodiment, appendage 122 may have a curved upper surface that won't interfere substantially with an edge 130 of aperture 126 when appendage 122 is being fit through aperture 126, as shown in FIG. 4A.

In one embodiment, appendage 122 may have a thrust face 124 substantially normal to axis of rotation 110. In this embodiment, thrust face 124 may abut substantially edge 130 of aperture 126 when appendage 122 is passed through aperture 126, as shown in FIG. 3, and shaft 102 is rotated substantially upright to fit shank 104 in aperture 126, as shown in FIGS. 4A and 4B. In this embodiment, nut 132 may be rotated along shaft 102 to clamp member 136 without further need to grasp shank 104, or otherwise substantially prevent shank 104 and shaft 102 from rotating along with nut 132. In several embodiments, a fit between shank 104 and aperture 126 may be a slip fit, or an interference fit.

In a second embodiment, a method of self-securing a fastener may include the steps of rotating shaft 102 sideways to an oblique position 152 substantially oblique to aperture 126 to insert appendage 122 into aperture 126, passing appendage 122 through aperture 126, fitting a shank 104 attached to appendage 122 into a shape 128 of aperture 126, shank 104 having pattern 114 substantially similar to shape 128, rotating shaft 102 attached to shank 104 from oblique position 152 to a normal position 154 substantially normal to aperture 126, abutting a thrust face 124 of appendage 122 against edge 130 of aperture 126, and rotating nut 132 having internal thread 134 substantially helically about shaft 102 toward shank 104, and preventing shank 104 from turning substantially in aperture 126 while nut 132 is rotated helically about shaft 102.

On certain truck model chassis, an air reservoir may be mounted underneath the battery box and the battery hold-down may be secured with long studs, as shown in FIG. 5. These studs are secured to the bottom of the box with nuts and flat washers. When batteries must be replaced, the studs must be removed from the battery box so that the batteries can be removed and reinstalled. Removing the studs, however, may be difficult. To facilitate battery removal and reinstallation, carriage-style battery hold-down bolts may be used to replace the hold-down studs.

In one embodiment, a process of replacing hold-down bolts may be as follows:
1. Remove the access covers from the battery boxes on both sides of the vehicle.
2. Disconnect all the batteries (on both sides of the vehicle) by disconnecting the negative cable first, then the positive cable.
3. On the left-hand battery box, remove the four battery hold-down retaining nuts, and then remove the battery hold-down.
4. Remove the outermost battery hold-down stud, then remove the outer battery from the battery box.
5. Remove the outer-middle battery hold-down stud, then remove the center battery.
6. Remove the inner-middle battery hold-down stud.
7. Install a new hold-down bolt by inserting the head of the bolt into the square hole in the bottom of the battery box directly in front of the innermost battery. Stand the bolt straight up, then install the bolt retainer and slide it down the shank of the bolt to the bolt head.
8. Install the center battery.
9. Install a new hold-down bolt and bolt retainer.
10. Install the outermost battery.
11. Install the battery hold-down assembly by installing on the innermost stud first and starting the nut. Align the hold-down bolts with the holes in the hold-down, then seat the hold-down against the batteries. Install the nuts on all the bolts, then beginning at the center hold-down bolt and working outward, tighten all nuts evenly until snug.

The foregoing has described the principles, embodiments, and modes of operation of the present invention. However, the invention should not be construed as being limited to the particular embodiments described above, as they should be regarded as being illustrative and not restrictive. It should be appreciated that variations may be made in those embodiments by those skilled in the art without departing from the scope of the present invention.

While the invention has been described in detail above, the invention is not intended to be limited to the specific embodiments as described. It is evident that those skilled in the art may now make numerous uses and modifications of and departures from the specific embodiments described herein without departing from the inventive concepts.

While various embodiments of the present invention have been described above, they should be understood to have been presented by way of examples only, and not limitation. Thus, the breadth and scope of the present invention should not be limited by the above described embodiments.

Obviously, numerous modifications and variations of the present invention are possible in light of the above teachings. It is therefore to be understood that the invention may be practiced otherwise than as specifically described herein.

1. A self-securing fastener comprising:
a shaft;
a shank disposed at a head end of said shaft having a primary side substantially parallel to an axis of rotation of said shaft and a plurality of secondary sides arranged about said axis of rotation, said primary side and said secondary sides describing a pattern when viewed from a direction substantially normal to said axis of rotation;
an external thread disposed substantially helically at a tail end of said shaft distal from said head end; and
an appendage disposed fixedly to said primary side and extending substantially radially to said axis of rotation, said appendage having a thrust face substantially normal to said axis of rotation;
wherein said shank is prevented substantially from turning when said appendage is inserted in an aperture having a shape substantially similar to said pattern, said thrust face abuts substantially an edge of said aperture, and a nut having an internal thread substantially complementary to said external thread is rotated along said shaft.

2. The self-securing fastener of claim 1, wherein said appendage is selected from the group consisting of:
a hook,
a claw, and
a crow's foot.

3. The self-securing fastener of claim 1, wherein said pattern is selected from the group consisting of:
a square,
a triangle,
a quadrilateral,
a pentagon,
a hexagon,
a rhombus, and
a trapezoid.

4. The self-securing fastener of claim 1, wherein a fit between said shank and said aperture is selected from the group consisting of:
a slip fit, and
an interference fit.

5. A method of self-securing a fastener comprising:
passing an appendage through an aperture having a shape;
fitting a shank attached to said appendage into said aperture, said shank having a pattern substantially similar to said shape;
rotating a shaft attached to said shank from an oblique position substantially oblique to said aperture to a normal position substantially normal to said aperture;
abutting a thrust face of said appendage against an edge of said aperture; and
rotating a nut having an internal thread substantially helically about said shaft toward said shank; and
preventing said shank from turning substantially in said aperture while said nut is rotated helically about said shaft.

6. A system for self-securing a fastener comprising:
means for passing an appendage through an aperture having a shape;
means for fitting a shank attached to said appendage into said aperture, said shank having a pattern substantially similar to said shape;
means for rotating a shaft attached to said shank from an oblique position substantially oblique to said aperture to a normal position substantially normal to said aperture;
means for abutting a thrust face of said appendage against an edge of said aperture; and
means for rotating a nut having an internal thread substantially helically about said shaft toward said shank; and
means for preventing said shank from turning substantially in said aperture while said nut is rotated helically about said shaft.
